(19) United States
(12) Patent Application Publication
(10) Pub. No.: US 2009/0130053 A1
(43) Pub. Date: May 21, 2009

(54) NATURAL METHOD OF KILLING BACTERIA AND PATHOGENS IN ANIMAL SCENTS

(76) Inventor: Mark J. Weiser, Evans City, PA (US)

Correspondence Address: THE WEBB LAW FIRM, P.C., 700 KOPPERS BUILDING, 436 SEVENTH AVENUE, PITTSBURGH, PA, 15219, US

(21) Appl. No.: 12/272,345

(22) Filed: Nov. 17, 2008

Related U.S. Application Data
(60) Provisional application No. 60/988,249, filed on Nov. 15, 2007.

(51) Int. Cl. A01N 25/00; A01M 31/00; A01N 65/00; A01P 19/00; A01P 1/00

(52) U.S. Cl. 424/84; 43/1; 424/725

(57) ABSTRACT

The present invention relates to a composition for killing the bacteria and the pathogens that are present in animal scent attractants or animal scent repellents, including a plant derivative and an animal scent. Additionally, the present invention relates to a composition that enhances the scent emitted by animal scents, while naturally killing bacteria, pathogens and the like, in the animal scent attractants or repellants to make them safer for people to use.

### CROSS REFERENCE TO RELATED APPLICATION

This application claims the benefit of priority from U.S. Provisional Application No. 60/988,249, filed Nov. 15, 2007, entitled “Natural Method of Killing Bacteria and Pathogens in Animal Scents”, which is incorporated herein by reference in its entirety.

### BACKGROUND OF THE INVENTION

1. Field of the Invention

The present invention relates to scents used to attract or repel animals. More particularly, the present invention relates to a composition of matter for killing the bacteria and pathogens in animal scents.

2. Description of Related Art

Animal scents have been used by hunters and wildlife enthusiasts for a number of different purposes. A primary reason animal scents are used is to attract or to repel animals to or from a desired area. Pursuant to the same objective, animal scents are also used to disguise or mask human scent. Animals possess a keen sense of smell which can detect human scent from great distances and, consequently, keep the animals from the area in which the human is located.

Examples of animal scents are taught in U.S. Pat. No. 4,944,940 to Christenson, II and U.S. Pat. No. 5,672,342 to Bell. Christenson, II teaches an animal scent wherein urine from different animals is blended together. Bell teaches a method of making an animal scent kit using urine from a single animal.

Another example of an animal scent is taught in U.S. Pat. No. 6,149,901 to Weiser. Weiser discloses a composition of matter for amplifying and preserving animal scents consisting essentially of calcium carbonate and animal scent.

There is a potentially serious problem associated with utilizing animal scents; namely, animal scents may be contaminated with bacteria or pathogens. Thus, anyone using these products is faced with the potential of applying untreated animal scent and risks getting an infection or disease caused from bacteria or pathogen contamination.

Others have recognized this potential problem when handling and applying animal scent. U.S. Pat. No. 5,698,111 to Newman teaches a method of processing big game animal scent by pasteurizing and filtering collected animal urine to make it safe. Others have suggested using bleach to kill the bacteria.

A problem with the prior art is that even though pasteurization is an effective way to kill bacteria and pathogens in the animal scents, pasteurization may destroy or limit the effectiveness of many of the attracting or repelling compounds in the urine or other scent source and thus may eliminate its effectiveness as an animal attractant or repellent. Therefore, there is a need for an animal attracting or repelling composition that is free or substantially free from bacteria and pathogens, and thus safe for the user.

In a study performed at Cornell University, certain herbs and spices were found to have antimicrobial properties. Garlic, onion, allspice and oregano were found to kill approximately 100 percent of the bacteria tested (www.news.cornell.edu/Chronicle/98/3.5.98/spices.html). Thyme, cinnamon, tarragon, and cumin killed up to 80 percent of bacteria tested; capsaicin, including chilies and other hot peppers, killed or inhibited up to 75 percent of bacteria tested; while pepper (i.e., white pepper or black pepper) inhibited 25 percent of bacterial growth. In another study at Kansas State University, researchers found that cinnamon is effective for eliminating the E. coli present in unpasteurized apple juice (www.mediarelations.k-state.edu/WEB/News/NewsReleases/spices8109.html).

In U.S. Pat. No. 5,985,010 to Etscorn et al., pepper plant extracts were used to repel animals and in U.S. Pat. No. 6,635,266 to Messina a mixture of water, rosemary oil emulsion, and mint oil emulsion was used to repel animals.

What is needed is a composition of matter that naturally kills bacteria, pathogens, and the like, in any type of animal scent attractant or repellant to make them safer for people to use while amplifying and preserving animal scents, thus overcoming the problems found with prior art animal scents.

### SUMMARY OF THE INVENTION

The present invention relates to a composition for killing the bacteria and the pathogens that are present in animal scent attractants or animal scent repellents, including a plant derivative and an animal scent.

Particularly, the present invention relates to increasing the range and strength of an animal scent while using natural antimicrobial properties from herbal and spice extracts for killing bacteria, pathogens, and the like, in all types of animal scents. The composition for attracting or repelling animals includes a plant derivative and an animal scent.

Additionally, the present invention relates to a method of attracting or repelling animals, including providing a plant derivative, providing an animal scent and applying the plant derivative and the animal scent to a target and a plant derivative in an amount to kill bacteria and pathogens in the animal scent.

An alternative embodiment of the present invention is directed to a method of producing a composition for attracting or repelling animals, including providing a plant derivative, providing an animal scent and mixing an effective amount of the plant derivative with the animal scent.

Another embodiment of the present invention is directed to a method of killing bacteria and pathogens in animal scents comprising providing a plant derivative, providing an animal scent and applying an effective amount of the plant derivative to the animal scent.

### BRIEF DESCRIPTION OF THE DRAWINGS

FIG. 1 illustrates deer around the feeding stations when no repellent products were used;

FIG. 2 is a bar graph illustrating the amount of corn consumed by deer at a control site versus the amount of corn consumed at a site treated with a composition of the present invention;

FIG. 3 is a bar graph illustrating the amount of corn consumed at a control site versus the amount of corn consumed at a site treated with a composition of the present invention; and

FIG. 4 is a bar graph illustrating the amount of corn consumed at a control site versus the amount of corn consumed at a site treated with a composition of the present invention.

### BRIEF DESCRIPTION OF THE INVENTION

The present invention relates to a composition for enhancing, preserving, and killing the bacteria and the pathogens that are present in animal scent attractants or animal scent repellents to increase their effectiveness while making them safer for people to use.

In one embodiment of the present invention, the composition for attracting or repelling animals includes a plant derivative and an animal scent. The plant derivative of the present invention is provided in an amount to kill or inhibit pathogen and bacterial growth and can be an herb, a spice or a mixture thereof.

The term herb, as defined by the present invention, means a small, seed-bearing plant with fleshy, rather than woody, parts and may refer to herbaceous perennials, trees, shrubs, annuals, vines, and more primitive plants, such as ferns, mosses, algae, lichens, and fungi. Additionally, spice as defined by the present invention may mean a dried seed, fruit, root, balk or vegetative substance used in nutritionally insignificant quantities as a food additive for the purpose of flavoring.

The herb, spice or mixture thereof may be granular, powder, oil, liquid or a mixture or combination thereof. The grains or powder may range in size from about a 10 mesh to about a 30 mesh. Specifically, the grains or powder may have a size from about a 15 mesh to about a 20 mesh, for example, the grains or powder may have a size of about a 16 mesh. Various mesh sizes capable of use with the present invention include mesh sizes 16, 30, 40, 50, 60, 100, 200 and 325.

Although any plant derivative may be utilized in accordance with the present invention, specific plant derivatives capable of use may include garlic, cinnamon, clove, onion, thyme, rosemary, oregano, peppermint, ginger, capsaicin, allspice, lemongrass, black pepper, white pepper, sage or any mixture or combination thereof. In one specific embodiment, the plant derivative may be a mixture of garlic, cinnamon, clove, thyme, rosemary, peppermint, and white pepper. The plant derivative may include a mixture of cinnamon, clove, and white pepper, or the plant derivative may be cinnamon. The plant derivative may be present in the composition in an amount between about 0.00000001% and 99.99999999%.

The composition of the present invention will hereinafter be described more specifically by the following examples. All designations of “%” used in the following examples mean percent (%) by weight unless expressly noted.

The following are examples of compositions for preserving and amplifying animal scents:

EXAMPLE 1

| Ingredient | Percentage by weight |
|---|---|
| Liquid Animal Scent and Granular | 99.99752% |
| or Powder Calcium Carbonate | |
| Garlic Powder or Minced Garlic | 0.00125% |
| Cinnamon Powder | 0.00028% |
| Clove Powder | 0.00028% |
| White Pepper Powder | 0.00028% |
| Rosemary Powder | 0.00015% |
| Thyme Powder | 0.00015% |
| Peppermint Powder | 0.00009% |

EXAMPLE 2

| Ingredient | Percentage by weight |
|---|---|
| Granular Animal Scent and | 99.99752% |
| Granular or Powder Calcium | |
| Carbonate | |
| Minced Garlic Granules | 0.00125% |
| Cinnamon Powder | 0.00028% |
| Clove Powder | 0.00028% |
| White Pepper Powder | 0.00028% |
| Rosemary Powder | 0.00015% |
| Thyme Powder | 0.00015% |
| Peppermint Flakes | 0.00009% |

EXAMPLE 3

| Ingredient | Percentage by weight |
|---|---|
| Liquid Animal Scent and Granular | 99.99752% |
| or Powder Calcium Carbonate | |
| Garlic Oil | 0.00125% |
| Cinnamon Oil | 0.00028% |
| Clove Oil | 0.00028% |
| White Pepper Oil | 0.00028% |
| Rosemary Oil | 0.00015% |
| Thyme Oil | 0.00015% |
| Peppermint Oil | 0.00009% |

EXAMPLE 4

| Ingredient | Percentage by weight |
|---|---|
| Liquid Animal Scent, Sulfur, Urea, | 99.99752% |
| Granular or Powder Calcium | |
| Carbonate, and Water | |
| Cinnamon Powder | 0.00248% |

The animal scent composition of the present invention may include sulfur, urea and water, magnesium carbonate, sodium chloride, crystalline silica, and calcium carbonate. Specifically, the animal scent composition of the present invention may include between about 0.001% to about 99.75% calcium carbonate (i.e., between about 70.0% to 99.0% calcium carbonate or between 85.0%-95.0% by weight of calcium carbonate) and between about 0.001% to about 99.75% animal scent (i.e., between about 1-75% by weight animal scent; between about 2-50% by weight animal scent; between 3-25% by weight animal scent; or between 5-10% by weight of animal scent).

The animal scent composition of the present invention may be a liquid animal scent composition, a freeze-dried animal scent composition, a granular animal scent composition, a powdered animal scent composition, or any combination or mixture thereof. Alternatively, the animal scent used in the animal scent composition of the present invention may be glanular oil derived from an animal's gland.

The animal scent may be present in the composition in an amount between 0.001% to about 99.75% weight percent (i.e., between about 1-75% by weight; between about 2-50% by weight animal scent; between 3-25% by weight animal scent; or between 5-10% by weight of animal scent).

In one embodiment of the present invention, the animal scent may be selected from fox urine granules, coyote urine granules, deer urine granules, elk urine granules, fox urine, coyote urine, deer urine, elk urine, moose urine, bear urine, rabbit urine, fish oils, liquid animal glands, moose urine powder, bear urine powder, rabbit urine powder, fish oil granules, fox gel urine, coyote feces or mixtures thereof.

The animal scent may be used to attract or repel, for example, deer, rabbit, squirrel, mouse, rat, mole, vole, shrew, skunk, chipmunk, woodchuck, gopher, groundhog, porcupine, elk, beaver, armadillo, raccoon, possum, prairie dog, domestic and feral cats, as well as other like animals.

Generally, the composition for attracting or repelling animals may be applied to the areas where protection or attraction is desired. The application of the composition may occur in two phases, the initial phase and the follow-up phase. The initial phase application of the composition may be at an initial amount and during an initial time period, and the follow-up phase application may be at a follow-up amount, and during a follow-up period. The initial time period can range from one day to three weeks. Specifically, the initial application period can be two weeks long. During the initial application period, the composition may be applied once a day, once a week, twice a week, three times a week, four times a week, five times a week, or six times a week. Based on the duration and quantity of the initial application, the follow-up application of the composition may be once a day, once a week, twice a week, three times a week, four times a week, five times a week, or six times a week. In one embodiment of the present invention, the composition may be initially applied twice a week for two weeks and the follow-up application may be once a week.

In select embodiments of the present invention, the animal scent composition may be used to attract or repel burrowing animals, tunneling animals, or rodents. To attract or repel burrowing animals, the animal scent composition may be applied into holes, flower beds, or along foundations. The holes may be filled with, for example, dirt or soil after a specified time period, for example two weeks. Additionally, tunneling animals may be attracted or repelled by poking holes along tunnels created by the tunneling animals and sprinkling the animal scent composition for attracting or repelling animals into the holes. The holes may be filled with, for example, dirt or soil after a specified time period, for example two weeks. To attract or repel rodents, the animal scent composition for attracting or repelling animals may be applied near cracks or openings along the foundation of a house, garage, shed, building, or other area where rodents may enter.

### Efficacy Studies

Below are comparative examples of the impact of the animal scent composition on animal feeding. Specifically, the studies summarized in the following paragraphs evaluate the impact of the animal scent composition on the eating habits of different animals identified in the study such as deer, rabbit, squirrel, groundhog, opossum, raccoon, chipmunk and mice.

### Deer Efficacy Testing

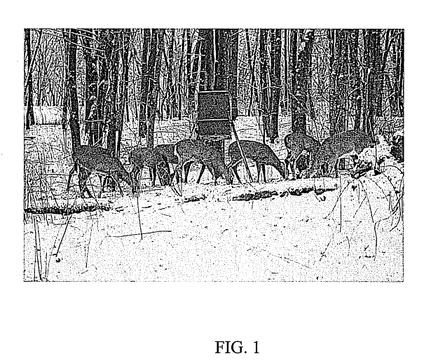

During the winter, there was a dense population of deer feeding on corn regularly at two feed stations (Test Station One and Test Station Two) for two months. No repellent products were used at the feeding stations during this time period so the wild deer were relaxed coming into the test sites (FIG. 1).

Corn was placed in the test areas by Sweeney electronic feeders (Sweeney Enterprises, Inc., 321 Waring Welfare Rd., Boerne, Tex. 78006) set on timers, releasing corn three times per day.

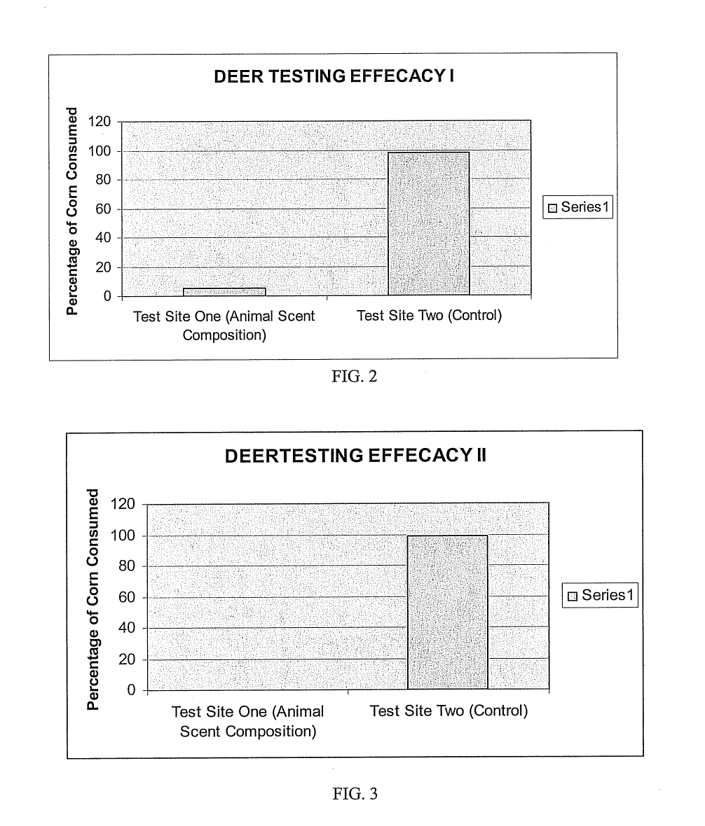

Test Station One was first treated with one embodiment of the animal scent composition (See Table 1) two times a week for a two-week period. Test Station Two, the control site, received no treatment. The portion of corn consumed by the deer in one day was determined and is the basis for evaluating the relative effects of the animal scent composition. (See Table 2 and FIG. 2 for results.)

TABLE 1
Animal Scent Compositon

| Ingredient | Percentage by weight |
|---|---|
| Liquid Animal Scent and Granular | 99.99752% |
| or Powder Calcium Carbonate | |
| Garlic Powder or Minced Garlic | 0.00125% |
| Cinnamon Powder | 0.00028% |
| Clove Powder | 0.00028% |
| White Pepper Powder | 0.00028% |
| Rosemary Powder | 0.00015% |
| Thyme Powder | 0.00015% |
| Peppermint Powder | 0.00009% |

TABLE 2
Deer Testing Efficacy

| | Proportion of Corn Consumed |
|---|---|
| Test Stations | by percentages (%) |
| Test Station One (Animal Scent | 5% |
| Composition) | |
| Test Station Two (Control) | 98% |

A second test was conducted at the same feed stations (Test Station One and Test Station Two). In this experiment, an alternative embodiment of the animal composition (See Table 3) was applied two times per week for two weeks to Test Station One. Once again, Test Station Two, the control site, received no treatment. The portion of corn consumed by the deer in one day was determined and is the basis for evaluating the relative effects of the animal scent composition. (See Table 4 and FIG. 3 for results.)

TABLE 3
Animal Scent Compositon

| Ingredient | Percentage by weight |
|---|---|
| Liquid Animal Scent and Granular | 99.99847% |
| or Powder Calcium Carbonate | |
| Garlic Powder or Minced Garlic | 0.00125% |
| Cinnamon Powder | 0.00028% |

TABLE 4
Deer Efficacy Testing

| | Proportion of |
|---|---|
| | Corn Consumed |
| Test Stations | by percentages (%) |
| Test Station One (Animal Scent | <1% |
| Composition) | |
| Test Station Two (Control) | >99% |

### Small Critter Efficacy Testing

During the summer, corn was placed in feed stations that were visited on a regular basis by wild rabbit, groundhog, squirrel, opossum, chipmunk, mice, and raccoon.

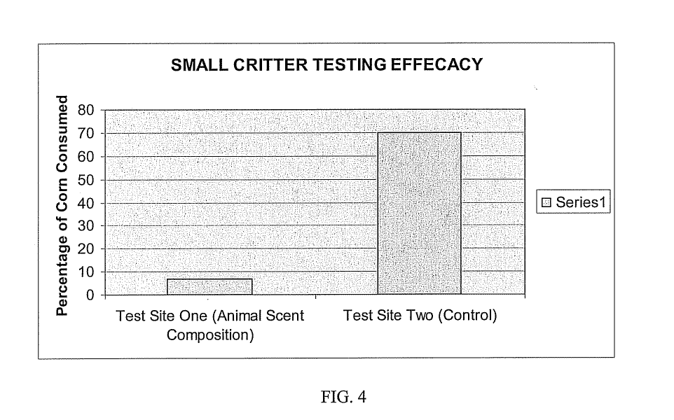

Test Site One was treated with an embodiment of the animal scent composition illustrated in Table 5 twice a week for a two-week period to determine the effectiveness of the animal scent composition around the feed station. Test Site Two, the control site, received no treatment. The portion of corn consumed by rabbit, groundhog, squirrel, opossum, chipmunk, mice and raccoon was determined and is the basis for evaluating the relative effects of the animal scent composition. (See Table 6 and FIG. 4 for results.)

TABLE 5
Animal Scent Compositon

| Ingredient | Percentage by weight |
|---|---|
| Liquid Animal Scent and Granular | 99.99752% |
| or Powder Calcium Carbonate | |
| Garlic Powder or Minced Garlic | 0.00125% |
| Cinnamon Powder | 0.00028% |
| Clove Powder | 0.00028% |
| White Pepper Powder | 0.00028% |
| Rosemary Powder | 0.00015% |
| Thyme Powder | 0.00015% |
| Peppermint Powder | 0.00009% |

TABLE 6
SMALL CRITTER EFFICACY TESTING

| | Proportion of |
|---|---|
| | Corn Consumed |
| Test Stations | by percentages (%) |
| Test Station One (Animal Scent | 7% |
| Composition) | |
| Test Station Two (Control) | 70% |

It is to be understood that the forms of the invention described are preferred embodiments thereof and that various changes and modifications may be made therein without departing from the spirit of the invention or scope as defined in the following claims.

The invention claimed is:

1. A composition for attracting or repelling animals comprising:
(a) an animal scent; and
(b) a plant derivative in an amount to kill bacteria and pathogens in the animal scent.

2. The composition for attracting or repelling animals of claim 1, wherein the plant derivative is one or more of an herb or a spice.

3. The composition for attracting or repelling animals of claim 1, wherein the plant derivative is selected from the group consisting of powder, oil, grains, liquids and mixtures and combinations thereof.

4. The composition for attracting or repelling animals of claim 1, wherein the plant derivative is one or more of garlic, cinnamon, clove, onion, thyme, rosemary, oregano, peppermint, ginger, capsaicin, allspice, lemongrass, black pepper, white pepper, and sage.

5. The composition for attracting or repelling animals of claim 1, wherein the plant derivative is present in an amount between about 0.00000001% and about 99.99999999% by weight.

6. The composition for attracting or repelling animals of claim 5, wherein the plant derivative is present in a weight percentage of about 0.00009% to about 0.00248%.

7. The composition for attracting or repelling animals of claim 1, wherein the animal scent is one or more of fox urine granules, coyote urine granules, deer urine granules, elk urine granules, fox urine, coyote urine, deer urine, elk urine, moose urine, bear urine, rabbit urine, fish oils, liquid animal glands, moose urine powder, bear urine powder, rabbit urine powder, fish oil granules, fox gel urine, and coyote feces or a mixture thereof.

8. The composition for attracting or repelling animals of claim 1, further comprising sulfur, urea, calcium carbonate and water.

9. The composition for attracting or repelling animals of claim 8, wherein the calcium carbonate is present in the composition in an amount between about 80-99% by weight.

10. A method for attracting or repelling animals comprising:
(a) providing an animal scent;
(b) providing a plant derivative in an amount to kill the bacteria and pathogens in the animal scent; and
(c) applying the plant derivative and the animal scent to a target.

11. The method of attracting or repelling animals of claim 10, wherein the plant derivative is one or more of an herb or a spice.

12. The method of attracting or repelling animals of claim 10, wherein the plant derivative is selected from the group consisting of grains, powder, oil, liquids and combinations and mixtures thereof.

13. The method of attracting or repelling animals of claim 10, wherein the plant derivative is one or more of garlic, cinnamon, clove, onion, thyme, rosemary, oregano, peppermint, ginger, capsaicin, allspice, lemongrass, black pepper, white pepper, and sage or a mixture thereof.

14. The method of attracting or repelling animals of claim 10, wherein the plant derivative is applied in an amount between about 0.00000001% and about 99.99999999% by weight.

15. The method of attracting or repelling animals of claim 14, wherein the plant derivative is applied in a weight percentage of about 0.00009% to about 0.00248%.

16. The method of attracting or repelling animals of claim 10, wherein the animal scent is one or more of fox urine granules, coyote urine granules, deer urine granules, elk urine granules, fox urine, coyote urine, deer urine, elk urine, moose urine, bear urine, rabbit urine, fish oils, liquid animal glands, moose urine powder, bear urine powder, rabbit urine powder, fish oil granules, fox gel urine, and coyote feces or a mixture thereof.

17. The method of attracting or repelling animals of claim 10, further comprising sulfur, urea, calcium carbonate and water.

18. The method of attracting or repelling animals of claim 17, wherein the calcium carbonate is present in the composition in an amount between about 80-99% by weight.

19. The method of attracting or repelling animals of claim 10, wherein the plant derivative and the animal scent are applied to the target two times a week for two weeks.

20. A method of producing a composition for attracting or repelling animals comprising:
(a) providing an animal scent;
(b) providing a plant derivative in an amount to kill the bacteria and pathogens in the animal scent; and
(c) mixing the plant derivative with the animal scent.

21. The method of producing a composition for attracting or repelling animals of claim 20, wherein the plant derivative is one or more of an herb or a spice.

22. The method of producing a composition for attracting or repelling animals of claim 20, wherein the plant derivative is selected from the group consisting of grains, powder, oil, liquid and combinations or mixtures thereof.

23. The method of producing a composition for attracting or repelling animals of claim 20, wherein the plant derivative is one or more of garlic, cinnamon, clove, onion, thyme, rosemary, oregano, peppermint, ginger, capsaicin, allspice, lemongrass, black pepper, white pepper, and sage or a mixture thereof.

24. The method of producing a composition for attracting or repelling animals of claim 20, wherein the plant derivative is applied in an amount between about 0.00000001% and about 99.99999999% by weight.

25. The method of producing a composition for attracting or repelling animals of claim 20, wherein the plant derivative is applied in a weight percentage of about 0.00009% to about 0.00248%.

26. The method of producing a composition for attracting or repelling animals of claim 20, wherein the animal scent is one or more of fox urine granules, coyote urine granules, deer urine granules, elk urine granules, fox urine, coyote urine, deer urine, elk urine, moose urine, bear urine, rabbit urine, fish oils, liquid animal glands, moose urine powder, bear urine powder, rabbit urine powder, fish oil granules, fox gel urine, and coyote feces or a mixture thereof.

27. The method of producing a composition for attracting or repelling animals of claim 20, further comprising sulfur, urea, calcium carbonate and water.

28. The method of producing a composition for attracting or repelling animals of claim 27, wherein the calcium carbonate is present in the composition in an amount between about 80-99% by weight.

29. A method of killing bacteria and pathogens in animal scents comprising:
(a) providing a plant derivative;
(b) providing an animal scent; and
(c) applying the plant derivative to the animal scent in the amount equal to about 0.00009% to about 0.00248% by weight.
